(19) United States
(12) Patent Application Publication
(10) Pub. No.: US 2008/0005756 A1
(43) Pub. Date: Jan. 3, 2008

(54) Recording of Data with Special Storage Space Requirements on a Storage Medium

(75) Inventors: Johannis Friso Rendert Blacquiere, Eindhoven (NL); Pope Ijtsma, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,616

(22) PCT Filed: Mar. 31, 2005
(86) PCT No.: PCT/IB05/51077

§ 371 Date: Aug. 1, 2007

(30) Foreign Application Priority Data
Apr. 9, 2004 (EP) 04101471.3

(51) Int. Cl. G11B 7/24

(52) U.S. Cl. 720/718

(57) ABSTRACT

The invention concerns a method, device and computer program product for recording a set of data (52) having certain storage requirements on a storage medium. An application obtains information about the free available storage area of the storage medium from an operating system, identifies at least one available space of the storage medium that corresponds to requirements for the set of data, orders the operating system to reserve an area, if the operating system writes data in at least one other space before the identified available space, which area corresponds to said other space for dummy storage data (50), and thereafter, orders the operating system to store the set of data (52), such that the operating system places the set of data in the identified available space.

### TECHNICAL FIELD

The present invention is generally directed towards recording of a set of data on a data carrier, for instance multimedia data on an optical disc, and in particular towards providing a method, device and computer program product for recording of a set of data having certain storage requirements on a data carrier, using a general medium storage handling scheme.

### BACKGROUND OF THE INVENTION

In recent years there have been developed a number of standards to record multimedia data on data carriers, examples of such standards being DVD (Digital Versatile Disc) and Blu-ray disc video. Traditionally, recordings on these types of discs are made by a specialized recorder arranged to only record these types of data on a disc.

It is however nowadays often of interest to combine this type of multimedia storage with other types of storage, perhaps according to another multimedia or media standard as well as normal data in a normal computer environment.

In this respect it is often desirable to include a recorder according to such a standard in a normal PC (personal computer). Then it is also of interest to combine the normal data storage with the storage of such multimedia.

Multimedia and especially streamed multimedia, does however in many cases have certain storage requirements in order to function properly. These requirements can for example be that a set of data has to be provided in a large enough contiguous section and/or two such contiguous sections might not be allowed to be too far spaced apart. In the case of Blu-ray, such requirements are normally that a contiguous data block should not be smaller than for example 12.5 MB or 25 MB. The reason for this is that normally the data read from a disc is stored in a buffer and it is essential that the data from one location on a disc is not emptied from the buffer before data read from another location is read into the buffer. These restrictions are then calculated based on for instance the longest jump time from location to location. Because of this, a user application that writes data on a disc needs to control in which location on the disc data is written.

If the application is provided in a PC, however, the standard writing mechanism used is normally optimized for storing ordinary computer data, and not for storing streamed multimedia data.

One way of allowing combined use of a storage medium is to reserve a part of the medium for the application and the rest for normal storage. This might however lead to the storage medium not being used to its full potential, if there is less application data being written than the space reserved.

If application data having the special requirements were to be more freely combined with other data, there might in some situations be fragmented areas of written data provided in a user data area. It is not a simple task then to guarantee that a suitable unwritten area is selected that meets the requirements of the application in such a PC environment.

Document EP-1209689 describes an AV (Audio Video) data recording apparatus for minimizing seeking, which uses a UDF file system for writing AV data, like MPEG data, on a data carrier. The AV data recording method used by the apparatus has file management information for managing continuous blocks on a disc as an extent of a file, wherein a new directory is created on a disk and an allocated extent rather than a recorded extent is kept as a reservation region for recording file management information. The seeking is minimized because the file management information is not distributed.

The document is silent regarding how to deal with fragments of written data provided in a user data area, when data having special storage space requirements is to be written.

There is thus a need for a recording scheme, where an application can select a memory space on a storage medium while still using a general storage handling mechanism.

### SUMMARY OF THE INVENTION

The present invention is therefore directed towards solving the above-mentioned problem of allowing selection of an available storage space on a storage medium for an application having special storage requirements, while still using a general storage handling mechanism for the medium in question.

One object of the present invention is thus to provide a method that allows selection of an available storage space on a storage medium for an application having special storage requirements, while still using a general storage handling mechanism for the medium in question.

According to a first aspect of the present invention, this object is achieved by a method of recording a set of data having certain storage requirements on a storage medium using a general medium storage handling scheme and comprising the steps of:

obtaining information about the free available storage area of the storage medium,

identifying at least one available space of the storage medium that corresponds to requirements for the set of data,

ordering that an area be reserved, if the handling scheme is arranged to write data in at least one other space before the identified available space, which area corresponds to said other space for dummy storage data, and

thereafter, ordering the storing of the set of data, such that the scheme places the set of data in the identified available space.

Another object of the present invention is to provide a device, which allows selection of an available storage space on a storage medium for an application having special storage requirements, while still using a general storage handling mechanism for the medium in question.

According to a second aspect of the present invention, this object is achieved by a device for recording a set of data having certain storage requirements on a storage medium and comprising:

a general storage medium handling unit arranged to control the reading and writing on the storage medium, and

an application unit for reading and writing data of a specific application format on the storage medium,

wherein the application unit is arranged to:

obtain information about the free available storage area of the storage medium via the general storage medium handling unit,

identify at least one available space of the storage medium that corresponds to requirements for the set of data,

order the handling unit to reserve an area, if the handling unit is arranged to write data in at least one other space before the identified available space, which area corresponds to said other space for dummy storage data, and

thereafter, order the handling unit to store the set of data, such that the storage medium handling unit places the set of data in the identified available space.

Yet another object of the present invention is to provide a computer program product that allows selection of an available storage space on a storage medium for an application having special storage requirements, while still using a general storage handling mechanism for the medium in question.

This object is achieved by a computer program product to be used on a computer for recording a set of data having certain storage requirements on a storage medium using a general storage medium handling scheme and comprising a computer program code for making the computer execute, when said code is loaded into the computer, the following jobs:

obtain information about the free available storage area of the storage medium from the general storage medium handling scheme,

identify at least one available space of the storage medium that corresponds to requirements for the set of data,

order the storage medium handling scheme to reserve an area, if the handling scheme is arranged to write data in at least one other space before the identified available space, which area corresponds to said other space for dummy storage data, and

thereafter, order the storage medium handling scheme to store the set of data, such that the scheme places the set of data in the identified available space.

According to claim 2, the dummy storage data is removed when the set of data has been written, in order to avoid unnecessary occupation of valuable space on the medium.

According to claim 3, the dummy storage data is sized to fit the whole free space provided before the selected area, in order to guarantee that nothing of the set of data is written into this area.

According to claim 4, the medium storage handling scheme used is investigated, which is necessary in case the application has no knowledge of it.

According to claim 5, the medium storage handling scheme is obtained through reserving space for initial dummy data to the medium. By analysing the placing of this reservation it is then possible to find out which scheme is used.

According to claim 6 and 7, the set of data includes multimedia data written according to the Blu-ray disc standard. This type of data has special requirements on the size of the data and/or location into which it is to be written.

According to claim 8, the storage medium is an optical disc. With this type of storage medium, the storage space requirements are more severe because of the required time for moving from one location to another before reading can be performed.

With the present invention there is provided the possibility to combine storage of data having special requirements regarding the storage location with an ordinary storage mechanism that does not allow this, which is advantageous when streamed media is to be stored. In this way no separate storing mechanism is needed for the media data. A separation of the medium for application data and other data is furthermore avoided. Another advantage is that the invention allows simpler implementation of multimedia storage in a normal computer environment, which enables the use of multimedia applications in a wider range of products.

The basic idea of the invention is to obtain information about the free available storage area of a storage medium, identify an available space of the storage medium that corresponds to requirements for data to be written, order that an area be reserved, if the handling scheme used for the storage medium is arranged to write data in another space before the identified space, which area corresponds to this other space for dummy data, and thereafter, order the storing of the data to be written, such that the scheme places the set of data in the identified available space.

The above-mentioned and other aspects of the invention will be apparent from and elucidated with reference to the embodiments described hereinafter.

### BRIEF DESCRIPTION OF THE DRAWINGS

The present invention will be further described in relation to the accompanying drawings, in which:

FIG. 1 schematically shows a device for recording a set of data according to the present invention in the form of a PC,

FIG. 2 shows a block schematic of the interior of the device according to the present invention,

FIG. 3 schematically shows the logical connection between application, operating system and medium drive unit in the device in FIG. 2,

FIG. 4 schematically shows the data structure of a storage medium having some previously written data on it,

FIG. 5 schematically shows a storage medium, where application data is stored according to a method in a first embodiment of the present invention,

FIG. 6 schematically shows a storage medium, where application data is stored according to a method in a second embodiment of the present invention, and

FIG. 7 schematically shows a computer program product in the form of a CD ROM disc having a computer program code for performing the method according to the present invention.

### DETAILED DESCRIPTION OF THE INVENTION

The present invention is generally directed towards combining the recording of media data streams with other types of data on a storage medium such as an optical disc.

The present invention is however not limited to optical discs; other types of storage mediums are just as well feasible, such as hard discs, memory sticks etc. In the following, the present invention will also be described in relation to a computer in the form of a PC (Personal Computer), but the invention is not limited to these types of devices. It can just as well be implemented in multimedia recording devices, such as video recorders having standard data storing capabilities, like Blu-ray recorders for additionally storing computer files like text files and program files.

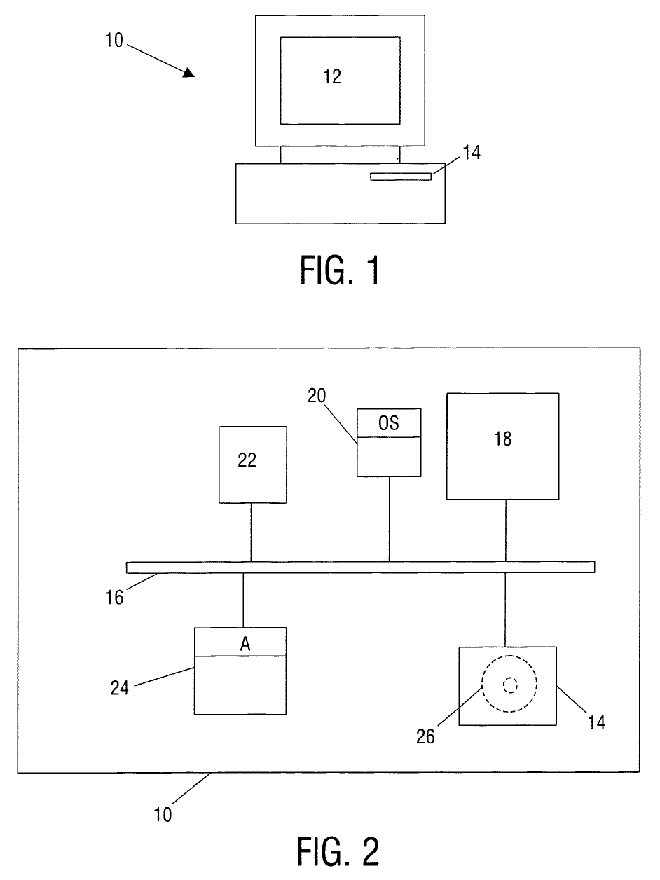

A device for carrying out the invention is schematically shown in FIG. 1, in the form of a PC 10 having an optical disc drive 14 and a display 12. The display can be used for things such as showing a video that has been recorded according to a suitable standard like for instance MPEG2.

FIG. 2 shows a block schematic of the parts relevant to the invention in the device 10. The device includes a data bus 16 to which a number of units are connected: a microprocessor 18 and a memory 20 including the operating system OS of the PC as well as additional units 22 and 24, where the unit 24 includes an application A for coding, storing and playing multimedia data according to a standardized format. The multimedia format can here be MPEG2 and the storage format can be Blu-ray. The unit 24 also preferably includes play-out buffers for buffering data. It should however be realized that other types of formats can be provided, such as other video coding formats or audio coding formats and also another storage format like DVD (Digital Versatile Disc). In order to store data on a storage medium in the form of an optical disc 26, a data medium drive unit in the form of a disc drive unit 14 is also connected to the data bus 16. The memory unit 22 can include another application, like for instance a text editing application or a gaming application, which application also could store ordinary computer data on the disc. It should be realized that the application A can be provided in the form of a software code, which performs the coding when the application is being run by the processor 18. It can also be provided as hardware, which performs the coding. There might furthermore be provided more processors, one of which is intended for the application. The different applications and operating systems need furthermore not be provided on separate units, but can be provided in one and the same unit. Storing of data on the disc 26 is then performed under the control of the operating system OS and using a standardized medium storage handling scheme or memory allocation scheme. The microprocessor 18 together with the operating system OS in memory 20 can in this respect therefore be seen as a general medium storage handling unit. The memory allocation scheme furthermore does not provide handles to the different storage or memory areas of the disc, which means that an application cannot directly select a memory location for storing of data. One type of format used here in a preferred variation of the invention is UDF (Universal Data Format) in order to store data on the disc. In order for the application A to store data on the disc, it thus has to store data via the operating system OS, which then normally uses a storing strategy that the application in question cannot directly influence.

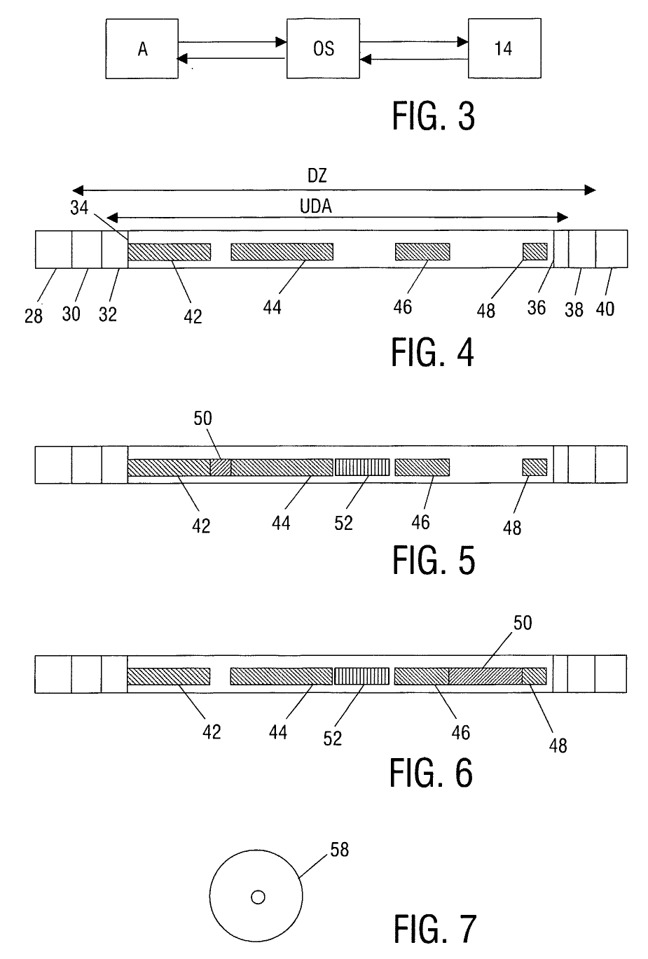

FIG. 3 shows how the normal control of reading and writing takes place in a logical sense via the disc drive 14. When the application A needs to write data to the disc drive 14 it has to communicate with the operating system OS, which performs the actual storing on a disc in the disc drive 14. Also reading of data by the application A is done via the operating system OS. Here queries and responses sent from the different devices are indicated with arrows.

As has been explained above, the normal data storage system does not provide the application A with direct control of the storage space of the medium. This is disadvantageous, since the multimedia data format often has certain requirements with respect to the space where the data is stored. One such requirement in the case of Blu-ray is that the data area where data is to be stored has to be contiguous and have a minimum size in order to guarantee effective playback of a stored multimedia file. This is due to the fact that data to be replayed is fed to a storage buffer and the application needs to ensure that the buffer is not emptied when data from a first location of the medium has to be played before data from a new location in a storage medium is filled into the buffer, which can take place when data is being read from an optical disc. Another situation is the simultaneous recording and playback from a disc. In this situation the application A would put data read from the disc in a playback buffer and then switch to recording data from a recording buffer to the disc, followed by yet again reading data into the playback buffer etc. When data is recorded, the data in the playback buffer is played. In this situation it is also necessary to ensure that the playback buffer is not emptied during recording while at the same time the recording buffer should be as empty as possible. Thus, also this situation puts requirements on the storage location. It should here be realized that the invention is not limited to multimedia files and these types of requirements, but that the invention is applicable to any application that has to control the location where files are stored on a storage medium without being provided with handles to the memory space in question.

In order to better understand the invention, a typical data storage layout for an optical disc is schematically shown in FIG. 4 and will now be described.

The data structure includes a lead-in zone 28 and a lead-out zone 40, between which is provided a data zone DZ. The data zone includes an inner spare area (ISA) 30 and an outer spare area (OSA) 38, between which is provided a user data area (UDA). The user data area includes a field 32 comprising UDF anchor and partition information. After the UDF anchor and partition information field 32 there is provided a UDF partition start marker 34, which is followed by actual data in the form of files and a UDF partition end marker 36. In the user data area there are shown a number of already allocated or occupied areas 42, 44, 46 and 48 comprising stored files, which can be any type of file like regular data files or multimedia files for streaming. The inner and outer spare areas 30 and 38 are reserved areas that can be used for storing of data in case there are deficiencies regarding the storage medium, i.e. for instance in case the disc is scratched. The UDF anchor and partition information field 32 is provided in a known position on the disc and includes pointers to the data area and the files stored there. Such information is, in the embodiment to be described, a free space bitmap, but this information can just as well be provided in other forms such as in a free space table.

The occupied areas 42, 44, 46, 48 include a first area 42 adjacent the UDF partition start marker 34. At a distance from the first occupied area 42 there is a second occupied area 44. There is thus provided a relatively small-sized free space between the first and second occupied areas 42 and 44, which can be used for writing data. At a greater distance from the occupied second area 44, in the direction of the partition end marker 36, there is shown a third occupied area 46. Between the second and third occupied areas 44 and 46 there is provided a medium-sized free space. After the third occupied area 46 there is provided a fourth occupied area 48 relatively close to the UDF partition end marker 36. Between the third and fourth occupied areas 46 and 48 there is provided a large, free available space. The different free available storage or memory spaces here have different sizes and the first available area between the first and second occupied areas 42 and 44 is smaller than a size limitation required by the application A, like for instance smaller than 12.5 MB. It should be realized that these occupied areas are just examples, which are shown in order to better describe the present invention.

A first aspect of the invention will now be described with reference to FIGS. 2, 3 and 4. The invention starts with the application A needing to write a set of data to the disc 26 in the disc drive 14, which set of data has certain storage requirements. The data is preferably multimedia data in the form of video data intended for streaming. In order to do this, the application A finds out which storage area is the free available storage area of the medium in the form of the free space bitmap of the disc 26. To this end, it sends a request for this information to the operating system OS, which goes on and retrieves this information in the form of a free space bitmap from the UDF anchor and partition information field 32 of the disc 26. The free space bitmap is then forwarded from the operating system OS to the application A, which bitmap includes the file information and corresponding positions as outlined in FIG. 4. As an alternative, the application A can get this information directly from the disc. From this free space bitmap the application A can identify a suitable available space on the medium 26 where multimedia data can be stored, which space fulfills the requirements of the standard used. In this example, it selects the area between the second and third occupied areas 44 and 46, since this space has a large enough size to accommodate the Blu-Ray requirements. However, since the operating system OS does not provide any direct handles to that specific space on the disc, the application A cannot go on and directly order the writing of the data, because then the writing might most probably not be made in the space selected.

If the application is not aware of the writing strategy used by the operating system OS, it now has to find out this strategy. The most common way to find out the strategy is to order the writing of a small dummy file or initial dummy data, which means that the application A orders the operating system OS to reserve a space on the disc corresponding to a file having a certain size. After this reservation has been made, the application A once again obtains the free space bitmap from the operating system OS, which fetches it from the disc 26 in the disc driver 14. When the application receives this adjusted free space bitmap it compares it with the previously received free space bitmap. The difference between the bitmaps indicates where a space has been reserved for this dummy file and from this information the application can find out what writing strategy the operating system uses. It is possible that this dummy file is actually written to the disc instead of being merely reserved. In that case, the dummy file is removed or at least the reservation is removed. It might be necessary to eject the disc and reinsert it before an updated free space bitmap can be received. If it is possible to query the storage scheme used, the application A could query the operating system OS, which would then inform the application A of the scheme. In this case dummy files would naturally not be used. After this, the application retains the information about the strategy used and keeps this for future use. Therefore, this step is normally performed only once for the application and can then be used for several discs. Another possible alternative is that the application knows about the storage strategy beforehand, in which case there would of course not be a need for this finding out either.

Now a second aspect of the present invention will be described, that is directed towards the actual storing of data on the disc. Once the strategy is known, the application A can go on and ensure that the data is stored in the position selected. One way of doing this according to a first embodiment of the present invention will now be explained with further reference being made to FIG. 5, which shows the same data structure as FIG. 4, yet with the addition of a dummy file 50 provided between the first and second occupied areas 42 and 44 and an actual data file 52 provided between the second and third occupied areas 44 and 46. Here the operating system OS uses the first free block strategy, i.e. the operating system OS writes data into the first available space on the disc after the UDF partition start marker. The application now creates dummy storage data in the form of a dummy file 50 or at least information about a dummy file sized to fit in all the available free spaces present before the intended available free space between the second and third occupied areas 44 and 46. The application now orders the operating system to reserve space for the dummy file 50. In this way the operating system OS reserves the first free space, which is the free space between the first and second occupied spaces 42 and 44, for the dummy file 50. After this has been done, the next available space to be written by the operating system OS is the one selected by the application A. The application A therefore now orders the operating system OS to write the actual data, i.e. the multimedia file or files to be stored. This is then done automatically in the space selected, since the space is the one available according to the strategy or scheme used. Thus, now the actual data file 52 is stored in the selected area. When this has been done, the reservation for the dummy file 50 is removed such that this space is free again for storing other data.

A second embodiment of the present invention will now be described in relation to FIG. 6, which shows the situation when a second strategy is used for the same data structure shown in FIG. 4, yet with the addition of the dummy file 52 and actual data 52. Here the strategy is the so-called Largest Area First Strategy. According to this strategy the operating system OS first selects the free area that is largest. Since in the example given and shown in FIG. 4, this area is the area between the third and fourth occupied areas 46 and 48, the application A now creates dummy data for reserving that whole region. The next area to be written is the intended area between the second and third occupied spaces 44 and 46. Once this largest area has been reserved, the application A orders the operating system OS to write the multimedia data 52, which will then be placed in the intended area. The dummy file 50 is then removed again or rather the reservation for the dummy file is then removed so that storage space is not unnecessarily occupied. Here it should be realized that it is possible that less than the whole region is reserved. It might for instance be possible to reserve only as much as necessary of the area in question, such that it is not the largest area any more, or to reserve an area in between these extremes.

In both embodiments described above, the dummy file 50 is sized according to the storage scheme, such that enough of the available space that would be written before the intended location is reserved in order for the scheme to point to the intended location after the reservation. It should be realized that the dummy file could just as well be actually written to the disc instead of being only reserved. It should furthermore be realized that if the scheme directly points at the area selected, there will naturally not be made any reservation for dummy data before the actual data is written.

It should be realized that the invention is not limited to multimedia data, but can be applied for any type of data where an application imposes certain requirements on the location of storage. It is furthermore possible to reserve storage space for dummy data after parts of a file or a whole file of data has been written, and then allow the rest of the file or a next file to be stored in another space. Naturally, the storage space is selected such that it meets the requirements of the application. It is furthermore possible to provide more than one dummy file for an area. The invention is furthermore not limited to UDF, but can be implemented for any suitable scheme not providing handles to free available space.

As mentioned earlier, the application is preferably provided in the form of program code in a memory, which performs the invention when run by the processor. This program code can also be provided on a data carrier, for example in the form of a CD Rom disc 58 as shown in FIG. 8. The program code can furthermore be provided on a server and downloaded into a computer.

With the present invention, there is thus provided the possibility to combine storage of data having special requirements regarding the storage location with an ordinary storage mechanism that does not allow this, which is advantageous when streamed media is to be stored. In this way no separate storing mechanism is needed. Such a double control is unwanted, since it would permit conflicts to occur if two separate applications need to store data simultaneously. In order to solve such a conflict, there would be required either a priority mechanism, which would make the device more complex and expensive, or separate drivers for application data and other data, which would also make the device more complex. A separation of the medium for application data and other data might lead to suboptimal use of the disc space. Another advantage is that it allows simpler implementation of multimedia storage in a normal computer environment, which enables the use of multimedia applications in a wider range of products.

It should be emphasized that the term “comprises/comprising” when used in this specification is taken to specify the presence of stated features, integers, steps or components, but does not preclude the presence or addition of one or more other features, integers, steps, components or groups thereof. It should furthermore be realized that reference signs appearing in the claims should in no way be construed as limiting the scope of the present invention.

1. Method of recording a set of data (52) having certain storage requirements on a storage medium (26) using a general medium storage handling scheme (OS) and comprising the steps of:
obtaining information about the free available storage area of the storage medium,
identifying at least one available space of the storage medium that corresponds to requirements for the set of data,
ordering that an area be reserved, if the handling scheme is arranged to write data in at least one other space before the identified available space, which area corresponds to said other space for dummy storage data (50), and
thereafter, ordering the storing of the set of data (52), such that the scheme places the set of data in the identified available space.

2. Method according to claim 1, further comprising the step of ordering the removal of the reservation for the dummy storage data once the set of data has been written.

3. Method according to claim 1, wherein the area to be reserved for said dummy storage data is equal to the whole other space before the identified available space of the free available storage area.

4. Method according to claim 1, further comprising the step of identifying the medium storage handling scheme used, and the step of ordering reserving space comprises ordering reserving space for dummy storage data sized according to the medium storage handling scheme.

5. Method according to claim 4, wherein the step of identifying the medium storage handling scheme comprises ordering reserving space for initial dummy data, obtaining information of changes of the free available storage area after the reservation and, thereafter, removing the reservation for the initial dummy data.

6. Method according to claim 1, wherein the set of data includes multimedia data according to a multimedia standard.

7. Method according to claim 6, wherein the standard is the Blu-ray disc standard.

8. Method according to claim 1, wherein the storage medium is an optical disc (26).

9. Device (10) for recording a set of data (52) having certain storage requirements on a storage medium (26) and comprising:
a general storage medium handling unit (18, 20, OS) arranged to control the reading and writing on the storage medium, and
an application unit (A) for reading and writing data of a specific application format on the storage medium,
wherein the application unit is arranged to:
obtain information about the free available storage area of the storage medium via the general storage medium handling unit,
identify at least one available space of the storage medium that corresponds to requirements for the set of data,
order the handling unit to reserve an area, if the handling unit is arranged to write data in at least one other space before the identified available space, which area corresponds to said other space for dummy storage data (50), and
thereafter, order the handling unit to store the set of data (52), such that the storage medium handling unit places the set of data in the identified available space.

10. Device according to claim 9, further comprising a data medium drive unit (14) for reading and writing data on an associated storage medium.

11. Computer program product (58; A) to be used on a computer for recording a set of data (52) having certain storage requirements on a storage medium (26) using a general storage medium handling scheme (OS) and comprising a computer program code for making the computer execute, when said code is loaded into the computer, the following jobs:
obtain information about the free available storage area of the storage medium from the general storage medium handling scheme,
identify at least one available space of the storage medium that corresponds to requirements for the set of data,
order the storage medium handling scheme to reserve an area, if the handling scheme is arranged to write data in at least one other space before the identified available space, which area corresponds to said other space for dummy storage data (50), and
thereafter, order the storage medium handling scheme to store the set of data, such that the scheme places the set of data in the identified available space.
